(19) United States
(12) Patent Application Publication
(10) Pub. No.: US 2022/0092656 A1
(43) Pub. Date: Mar. 24, 2022

(54) TRANSACTION MEDIATION DEVICE AND TRANSACTION MEDIATION METHOD

(71) Applicant: Hitachi, Ltd., Tokyo (JP)

(72) Inventors: Ichiro KURIMA, Tokyo (JP); Tomohiro SHIGEMOTO, Tokyo (JP); Nobutaka KAWAGUCHI, Tokyo (JP); Katsuya NISHIJIMA, Tokyo (JP)

(73) Assignee: Hitachi, Ltd.

(21) Appl. No.: 17/204,767

(22) Filed: Mar. 17, 2021

(30) Foreign Application Priority Data
Sep. 23, 2020 (JP) 2020-158211

(51) Int. Cl. G06Q 30/06; G06Q 30/02; G06Q 40/00

(52) U.S. Cl. CPC G06Q 30/0605; G06Q 40/12; G06Q 30/0206

(57) ABSTRACT

A transaction mediation device stores transaction request information indicating estimates of profit and loss obtained by the first participant through the transaction; transaction provision information indicating estimates of profit and loss incurred based on a thing that the second participant obtains through the transaction; and behavior characteristic information indicating evaluation of behavior characteristics that affect the profit and loss of a transaction counterparty, and, for each of the one or more second participants, calculates, based on the transaction request information and the behavior characteristic information, a first expected profit that the first participant obtains through the transaction with the second participant and a second expected profit that the second participant obtains through the transaction with the first participant; and calculates and outputs a gross profit incurred from the transaction based on the first expected profit and the second expected profit.

### CLAIM OF PRIORITY

The present application claims priority from Japanese patent application JP 2020-158211 filed on Sep. 23, 2020, the content of which is hereby incorporated by reference into this application.

### BACKGROUND

The present invention relates to a transaction mediation device and a transaction mediation method.

As a background technology of this technical field, Japanese Patent Application Publication No. 2002-207928 (Patent Document 1) is known. This publication discloses “an electronic commerce server device that is connected to a user terminal via an information network and conducts electronic commerce, in which the device requests a buyer-side user and a seller-side user to evaluate the reliability of transaction counterparties at the end of transaction, receives seller evaluation information and buyer evaluation information related to the transaction counterparties transmitted from the user terminals, creates for each user, seller evaluation data and buyer evaluation data of the buyer-side user and the seller-side user on the basis of the seller evaluation information and the buyer evaluation information, accumulates the evaluation data in a database, and provides evaluation data related to other users who will be transaction counterparties of a user who conducts electronic commerce” (see Abstract).

### SUMMARY

Since the technique disclosed in Patent Document 1 evaluates the reliability of a transaction counterparty, the transactor can consider whether to deal with the other party on the basis of the reliability. However, since the technique disclosed in Patent Document 1 does not evaluate a transaction counterparty on the basis of information other than reliability, such as profit or loss obtained from a transaction, for example, the transactor may not be able to select an appropriate transaction counterparty. Therefore, in one aspect of the present invention, a transaction counterparty is selected so that profits and losses are optimized.

The one aspect of the present invention adopts the following construction in order to solve the above problem. A transaction mediation device that mediates between a first participant requesting a transaction and one or more second participants capable of responding to the request of the transaction, comprising: a processor; and a memory, wherein the memory is configured to store: transaction request information indicating estimates of profit and loss incurred on the basis of a thing that the first participant obtains through the transaction; for each of the one or more second participants, transaction provision information indicating estimates of profit and loss incurred on the basis of a thing that the second participant obtains through the transaction; and for each of the first participant and the one or more second participants, behavior characteristic information indicating evaluation of behavior characteristics that affect the profit and loss of a transaction counterparty, and the processor is configured to: for each of the one or more second participants, calculate a first expected profit that the first participant obtains through the transaction with the second participant on the basis of the transaction request information and the behavior characteristic information; calculate a second expected profit that the second participant obtains through the transaction with the first participant on the basis of the transaction provision information and the behavior characteristic information; and calculate and output a gross profit incurred from the transaction on the basis of the first expected profit and the second expected profit.

The one aspect of the present invention can select the transaction counterparty so that profits and losses are optimized.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

The present invention can be appreciated by the description which follows in conjunction with the following figures, wherein:

FIG. 1 is a block diagram illustrating a configuration example of a service mediation system;

FIG. 2 is an example of participant data;

FIG. 3 is an example of service data;

FIG. 4 is an example of service provision method data;

FIG. 5 is an example of participant behavior characteristic item data;

FIG. 6 is an example of participant behavior characteristic data;

FIG. 7 is an example of request record data;

FIG. 8 is an example of provision record data;

FIG. 9 is an example of evaluation record data;

FIG. 10 is a sequence diagram illustrating an example of service mediation processing;

FIG. 11 is a sequence diagram illustrating an example of transaction record evaluation processing from a service requester to a service provider;

FIG. 12 is a sequence diagram illustrating an example of transaction record evaluation processing from the service provider to the service requester;

FIG. 13 is a flowchart illustrating an example of optimal transaction condition calculation processing;

FIG. 14 is a flowchart illustrating an example of transaction record update processing;

FIG. 15 is a flowchart illustrating an example of transaction record evaluation update processing;

FIG. 16 is a flowchart illustrating an example of participant behavior characteristic update processing in step;

FIG. 17 is an example of a service request input screen displayed on a participant terminal of the service requester;

FIG. 18 is an example of a service provision condition input screen displayed on the participant terminal of a service provider candidate;

FIG. 19 is an example of a transactability determination input screen displayed on the participant terminal of the service provider candidate;

FIG. 20 is an example of a transaction counterparty selection screen displayed on the participant terminal of the service requester; and

FIG. 21 is an example of the transaction evaluation information input screen displayed.

### DETAILED DESCRIPTION OF EMBODIMENTS

Hereinafter, embodiments of the present invention are described in detail with reference to the drawings. In the present embodiment, in principle, the same components are designated by the same reference numerals, and the repeated description is omitted. It should be noted that the present embodiment is merely an example for realizing the present invention and does not limit the technical scope of the present invention.

### Example 1

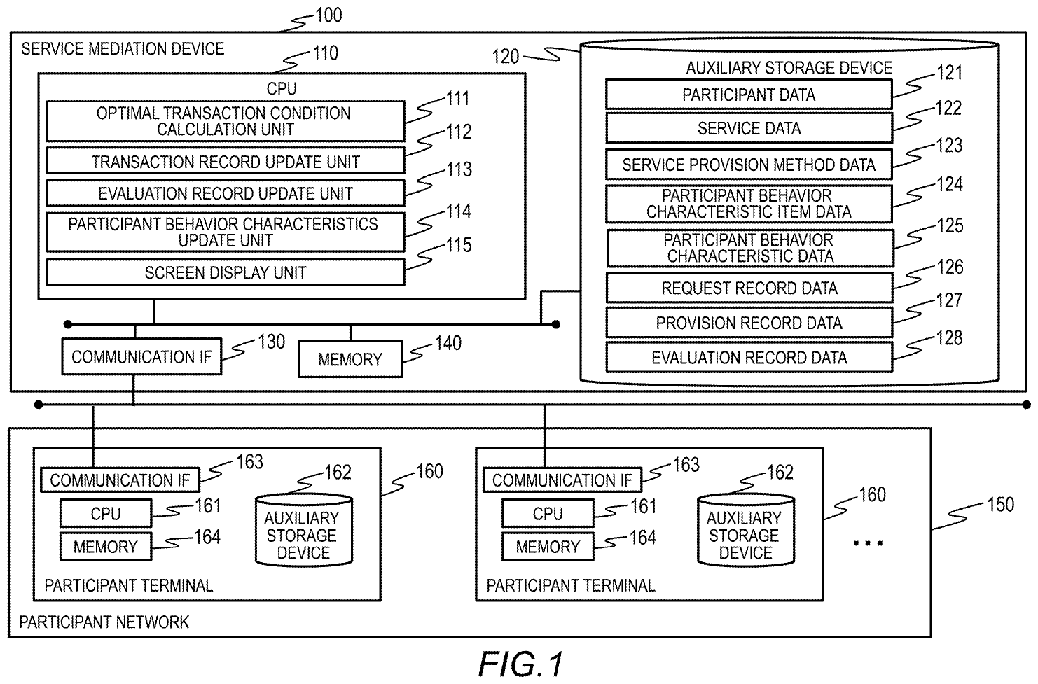

FIG. 1 is a block diagram illustrating a configuration example of a service mediation system. The service mediation system includes a service mediation device 100 and a plurality of participant terminals 160, which are connected to each other by a network such as the Internet. The plurality of participant terminals 160 belong to, for example, a participant network 150. The participant terminal 160 is a terminal used by a service requester or a service provider.

When the participant terminal 160 receives the input of a service request from a service requester, the participant terminal 160 transmits the service request to the service mediation device 100, and the service mediation device 100 transmits the service provision request to the participant terminal 160 of the service provider. The service mediation device 100 performs mediation so that a transaction is established between the service requester and the service provider.

In the present embodiment, both the service requester and the service provider may be able to receive a service from the other party or may be able to provide a service to the other party. In this case, the service requester is a person who wishes to start a transaction, and the service provider is a person who has the ability to accept the transaction according to the request from the service requester. Receiving services and providing services are both examples of transactions. In addition, each service provision method described later is an example of a transaction means.

Further, in the present embodiment, an example in which data is exchanged between a service requester and a service provider of a service is described, but a service may not involve exchanging data. Further, in the present embodiment, an example in which the service mediation system mediates the service is described, but various mediations such as buying and selling and exchanging of articles may be performed by the processing similar to the processing described later.

The service mediation device 100 is configured as, for example, a computer having a CPU (Central Processing Unit) 110, an auxiliary storage device 120, a communication IF (interface) 130, and a memory 140.

The CPU 110 includes a processor and executes a program stored in the memory 140. The memory 140 includes a ROM (Read Only Memory) which is a non-volatile storage element and a RAM (Random Access Memory) which is a volatile storage element. The ROM stores an invariant program (for example, BIOS (Basic Input/Output System)) and the like. The RAM is a high-speed and volatile storage element such as a DRAM (Dynamic Random Access Memory), and temporarily stores a program executed by the CPU 110 and data used when the program is executed.

The auxiliary storage device 120 is a large-capacity, non-volatile storage device such as a magnetic storage device (HDD (Hard Disk Drive)) or a flash memory (SSD (Solid State Drive)), and stores a program executed by the CPU 110 and the data used when the program is executed. That is, the program is read from the auxiliary storage device 120, loaded into the memory 140, and executed by the CPU 110.

The service mediation device 100 may include an input interface that is connected to an input device such as a keyboard or a mouse to receive input from an operator and an output interface that is connected to a display device such as a display or a printer to output the program execution result in a format that the operator can see.

The communication IF 130 is a network interface device that controls communication with other devices according to a predetermined protocol. Further, the communication IF 130 may include a serial interface such as USB.

The program executed by the CPU 110 may be stored in advance in a non-volatile auxiliary storage device 120 which is a computer-readable non-transitory storage medium, or may be provided from a removable medium (CD-ROM, flash memory, or the like) which is a non-transitory storage medium or a non-transitory storage device of another device to the service mediation device 100 via a network and be stored in the auxiliary storage device 120. Therefore, the service mediator 100 may have an interface for reading data from removable media.

The service mediation device 100 is a computer system configured on one computer physically or on a plurality of computers configured logically or physically, and may operate in separate threads on the same computer and may operate on a virtual computer built on a plurality of physical computer resources. The same applies to the participant terminal 160.

The CPU 110 includes, for example, an optimal transaction condition calculation unit 111, a transaction record update unit 112, an evaluation record update unit 113, a participant behavior characteristics update unit 114, and a screen display unit 115. The optimal transaction condition calculation unit 111 calculates the optimized transaction condition between the service requester and the service provider (candidate). The evaluation record update unit 113 updates the evaluation record for each behavior characteristic item of the service requester and the service provider who conducted the transaction.

The participant behavior characteristics update unit 114 calculates the behavior characteristic evaluation value for each behavior characteristic classification of the participant on the basis of the evaluation record updated by the evaluation record update unit 113. The screen display unit 115 generates information for forming an image displayed on the display device of the service mediation device 100 and the display device of the participant terminal 160.

For example, the CPU 110 functions as the optimal transaction condition calculation unit 111 by operating according to an optimal transaction condition calculation program loaded in the memory 140, and functions as the transaction record update unit 112 by operating according to a transaction record update program loaded in the memory 140. The relationship between the program and the functional unit is the same for the other functional units included in the CPU 110.

In addition, a part or all of the functions of the functional units included in the CPU 110 may be realized by hardware such as ASIC (Application Specific Integrated Circuit) and FPGA (Field-Programmable Gate Array).

The auxiliary storage device 120 includes, for example, participant data 121, service data 122, service provision method data 123, participant behavior characteristic item data 124, participant behavior characteristic data 125, request record data 126, provision record data 127, and evaluation record data 128. The participant data 121 holds information on a participant having the participant terminal 160. The service data 122 holds information on services that any participant can provide.

The service provision method data 123 holds information on a service provision method and information on the cost, profit, and loss related to the provision of the service. The participant behavior characteristic item data 124 holds information that defines the behavior characteristic item. The participant behavior characteristic data 125 holds information on the evaluation of the behavior characteristic classification of each participant.

The request record data 126 holds information indicating the record of the service requester transmitting the service request. The provision record data 127 holds information indicating the record of the service provider providing the service. The evaluation record data 128 holds the evaluation value for each behavior characteristic in a transaction, of the participants (combination of a service requester who received the service and a service provider who provided the service) who established the transaction in the past.

Part or all of pieces of the information stored in the auxiliary storage device 120 may be stored in the memory 140, or may be stored in an external database or the like connected to the service mediation device 100.

In the present embodiment, the information used by the service mediation system may be represented in any data structure regardless of the data structure. In the present embodiment, the information is represented in a table format, but for example, a data structure appropriately selected from a list, a database, or a queue can store the information.

Each of the participant terminals 160 includes, for example, a computer having a CPU 161, an auxiliary storage device 162, a communication IF 163, and a memory 164. The description of the CPU 161, the auxiliary storage device 162, the communication IF 163, and the memory 164 as hardware is the same as the description of the CPU 110, the auxiliary storage device 120, the communication IF 130, and the memory 140, and is therefore omitted.

Further, each of the participant terminals 160 may include an input interface to which an input device such as a keyboard or a mouse is connected, an output interface to which a display device such as a display or a printer is connected, and an interface that reads data from a removable medium, similarly to the service mediation device 100.

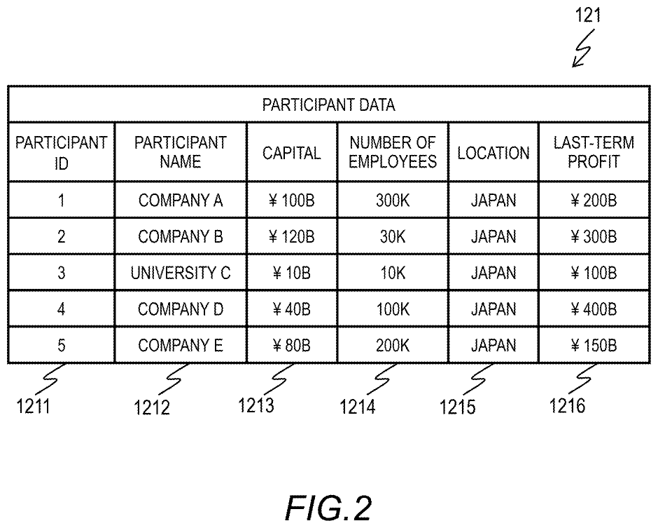

FIG. 2 is an example of the participant data 121. The participant data 121 includes, for example, a participant ID field 1211, a participant name field 1212, a capital field 1213, a number-of-employee field 1214, a location field 1215, and a last-term profit field 1216. The participant ID field 1211 holds a participant ID that identifies a user (participant) who uses the participant terminal 160. The participant name field 1212 holds information indicating the name of the participant.

The capital field 1213 holds information indicating the capital of the participants. The number-of-employees field 1214 holds information indicating the number of employees of the participant. The location field 1215 holds information indicating the location of the participant. The last-term profit field 1216 holds information indicating the last-term profit of the participant. In addition, the participant data 121 may include a field for storing information indicating the attributes and status of the participants in place of or in addition to the capital field 1213, the number-of-employees field 1214, the location field 1215, and the last-term profit field 1216.

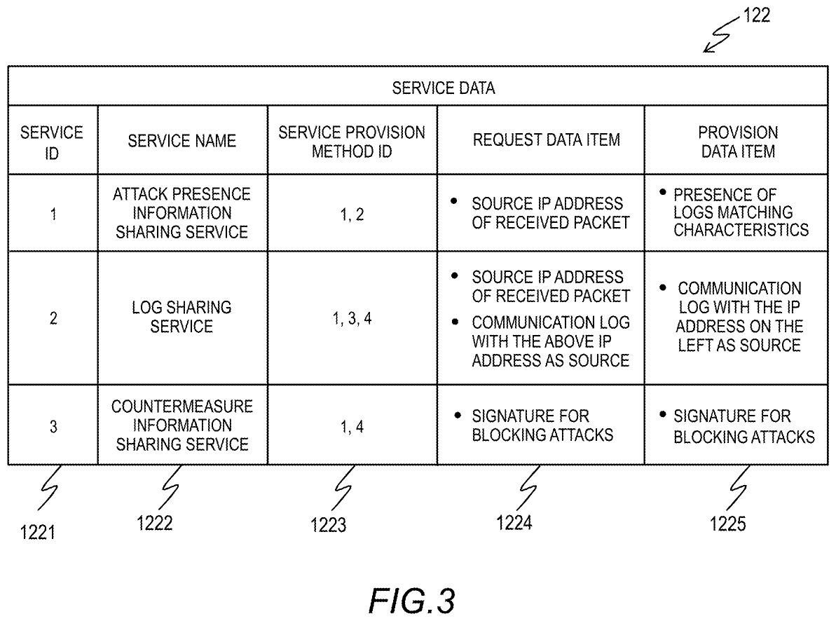

FIG. 3 is an example of the service data 122. The service data 122 includes, for example, a service ID field 1221, a service name field 1222, a service provision method ID field 1223, a request data item field 1224, and a provision data item field 1225. The service ID field 1221 holds a service ID that identifies the service. The service name field 1222 holds information indicating the name of the service.

The service provision method ID field 1223 holds a service provision method ID that identifies the service provision method. A service in which a plurality of IDs is stored in the service provision method ID field 1223 can be provided by a provision method indicated by each of the plurality of IDs. The request data item field 1224 holds information indicating data to be transmitted by the service requester to the service provider in the service. The provision data item field 1225 holds information indicating data to be transmitted by the service provider to the service requester in the service.

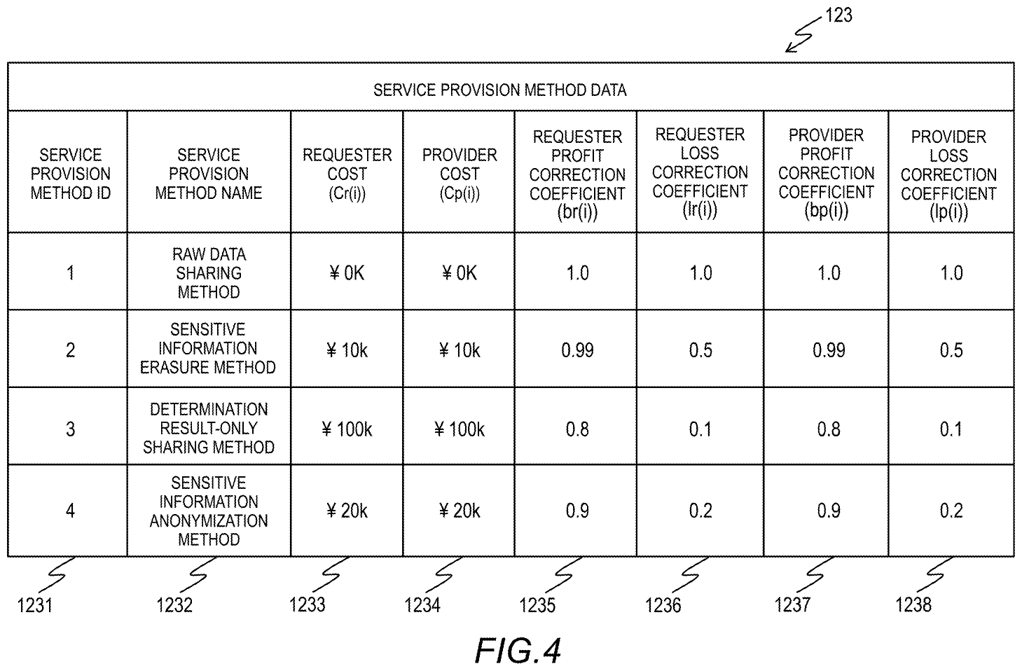

FIG. 4 is an example of the service provision method data 123. The service provision method data 123 includes, for example, a service provision method ID field 1231, a service provision method name field 1232, a requester cost field 1233, a provider cost field 1234, a requester profit correction coefficient field 1235, a requester loss correction coefficient field 1236, a provider profit correction coefficient field 1237, and a provider loss correction coefficient field 1238.

The service provision method ID field 1231 holds the service provision method ID. The service provision method name field 1232 holds information indicating the name of the service provision method. The requester cost field 1233 holds information indicating the cost incurred when the service requester requests the service (when conducting a transaction). The provider cost field 1234 holds information indicating the cost incurred when the service provider provides the service (when conducting a transaction).

The requester profit correction coefficient field 1235 holds a requester profit correction coefficient which is a coefficient for correcting the profit that the service requester obtains due to the service. The requester loss correction coefficient field 1236 holds a requester loss correction coefficient which is a coefficient for correcting the loss incurred by the service requester due to the service. The provider profit correction coefficient field 1237 holds a provider profit correction coefficient which is a coefficient for correcting the profit obtained by the service provider due to the service provider. The provider loss correction coefficient field 1238 holds a provider loss correction coefficient which is a coefficient for correcting the loss incurred by the service provider due to the service.

Hereinafter, the requester cost is Cr(i), the provider cost is Cp(i), the requester profit correction coefficient is br(i), the requester loss correction coefficient is lr(i), the provider profit correction coefficient is bp(i), and the provider loss coefficient is lp(i) (i indicates that it is the i-th service). It is desirable that Cr(i), Cp(i), br(i), lr(i), bp(i), and lp(i) are determined in advance before service mediation processing described below is executed. In the example of FIG. 4, a data provision method is illustrated as a service provision method, and br(i), lr(i), bp(i), and lp(i) are set to high values for the service provision method in which the information amount of data is less damaged.

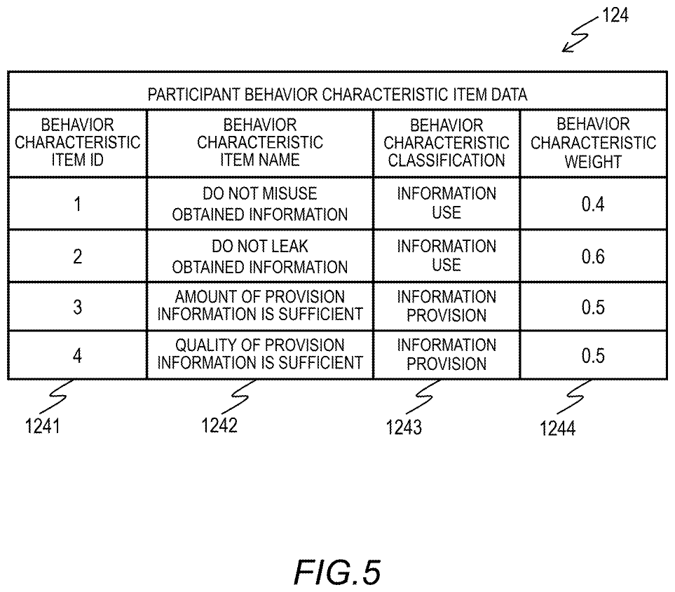

FIG. 5 is an example of the participant behavior characteristic item data 124. The participant behavior characteristic item data 124 includes, for example, a behavior characteristic item ID field 1241, a behavior characteristic item name field 1242, a behavior characteristic classification 1243, and a behavior characteristic weight field 1244. The behavior characteristic item ID field 1241 holds a behavior characteristic item ID that identifies the behavior characteristic. The behavior characteristic item name field 1242 holds information indicating the name of the behavior characteristic.

The behavior characteristic classification field 1243 holds information indicating the classification of the behavior characteristic. In the example of FIG. 5, the behavior characteristic item corresponding to the behavior characteristic classification of “information provision” is a behavior characteristic item related to provision of information to the other party. The behavior characteristic item corresponding to the behavior characteristic classification of “information use” is a behavior characteristic item related to the use of information obtained from the other party.

In the present embodiment, since the service in which information is provided and used between the service requester and the service provider is described, the behavior characteristic classification is composed of “information use” and “information provision”. However, when an arbitrary service is provided between the service requester and the service provider, the behavior characteristic classification is composed of behavior characteristics related to “profit” and behavior characteristics related to “loss” for the other party. The “information provision” is an example of behavior characteristics related to “profit”, and the “information use” is an example of behavior characteristics related to “loss”. In other words, when the present embodiment is applied to arbitrary service mediation, “information provision” to the other party should be read as “profit” for the other party, and “information use” obtained from the other party should be read as “loss” for the other party.

The behavior characteristic weight field 1244 holds a behavior characteristic weight which is a weight applied to each behavior characteristic item when the evaluation value of the participant for each behavior characteristic item is calculated. The behavior characteristic weights are set in advance so that the sum of behavior characteristic weights for respective behavior characteristic classifications is 1.0.

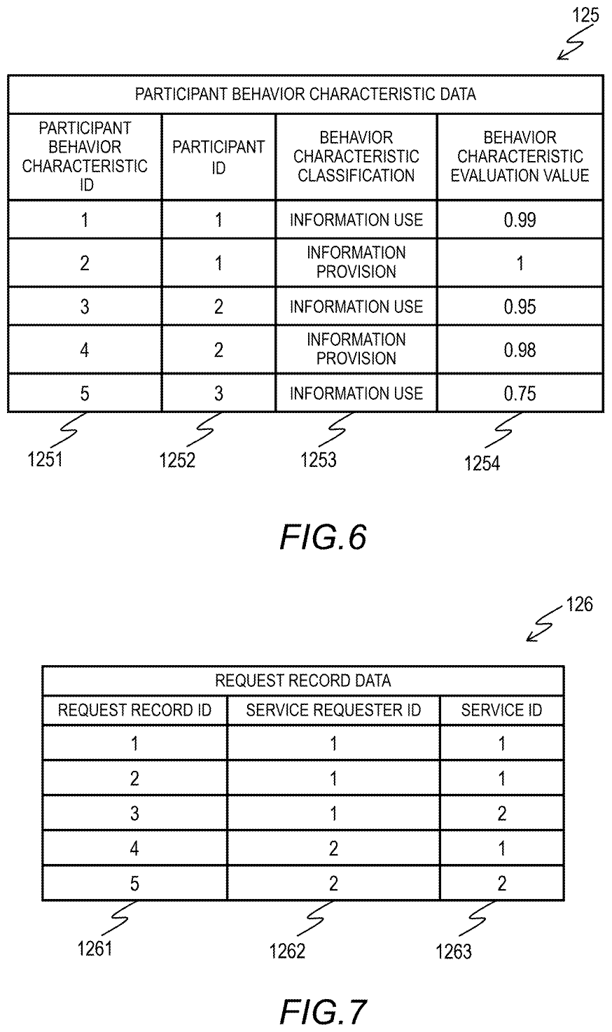

FIG. 6 is an example of the participant behavior characteristic data 125. The participant behavior characteristic data 125 includes, for example, a participant behavior characteristic ID field 1251, a participant ID field 1252, a behavior characteristic classification field 1253, and a behavior characteristic evaluation value field 1254. The participant behavior characteristic ID field 1251 holds a participant behavior characteristic ID that identifies the behavior characteristics of the participant. The participant behavior characteristic ID has a different value if at least one of the participant and the behavior characteristic is different.

The participant ID field 1253 holds the participant ID. The behavior characteristic classification field 1254 holds information indicating the behavior characteristic classification (“profit” or “loss” in the example of FIG. 6). The behavior characteristic evaluation value field 1254 holds a behavior characteristic evaluation value which is an evaluation value for each participant behavior characteristic.

FIG. 7 is an example of the request record data 126. The request record data 126 includes, for example, a request record ID field 1261, a service requester ID field 1262, and a service ID field 1263. The request record ID field 1261 holds a request record ID that identifies a service request. The service requester ID field 1262 holds a service requester ID which is a participant ID of the participant who transmitted the service request. The service ID field 1263 holds a service ID that identifies the service requested in the service request.

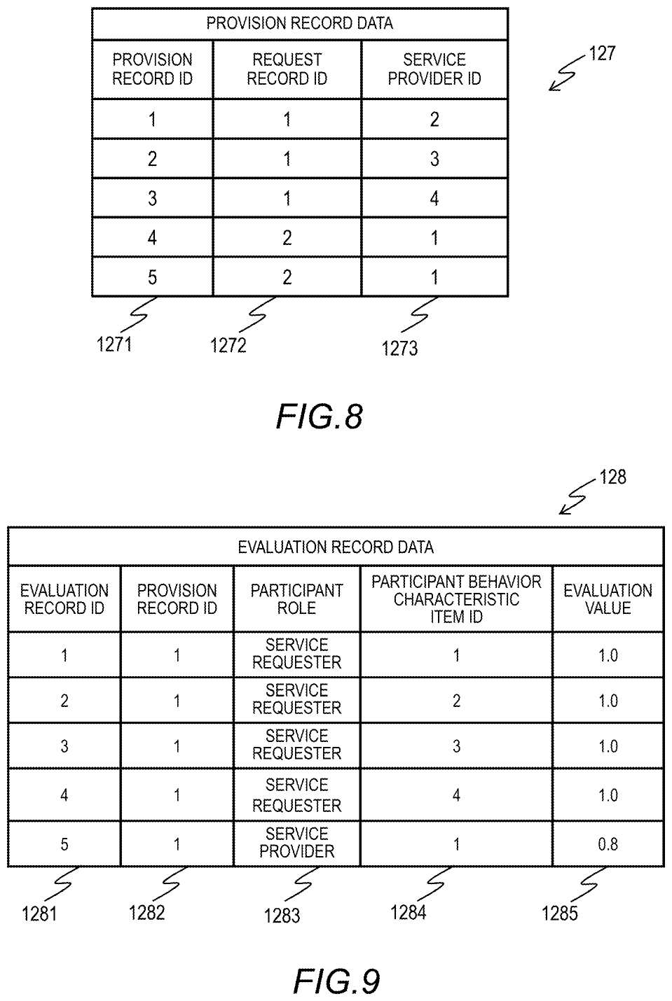

FIG. 8 is an example of the provision record data 127. The provision record data 127 includes, for example, a provision record ID field 1271, a request record ID field 1272, and a service provider ID field 1273. The provision record ID field 1271 holds a provision record ID that identifies the service provision record. The request record ID field 1272 holds the service request ID of the service request corresponding to the provided service. The service provider ID field 1273 holds the service provider ID which is the participant ID of the participant who provided the service in the provision record.

FIG. 9 is an example of the evaluation record data 128. The evaluation record data 128 includes, for example, an evaluation record ID field 1281, a provision record ID field 1282, a participant role field 1283, a participant behavior characteristic item ID field 1284, and an evaluation value field 1285. The evaluation record ID field 1281 holds an evaluation record ID that identifies the evaluation record. The evaluation record is generated for each participant behavior characteristic item ID of each of the service requester and the service provider corresponding to the provided service.

The provision record ID field 1282 holds the provision record ID. The participant role field 1283 holds information indicating whether the participant corresponding to the evaluation target participant behavior characteristic item is a service requester or a service provider. The participant behavior characteristic item ID field 1284 holds the participant behavior characteristic item ID. The evaluation value field 1285 holds the evaluation value for the participant behavior characteristic item of the participant in the provision record.

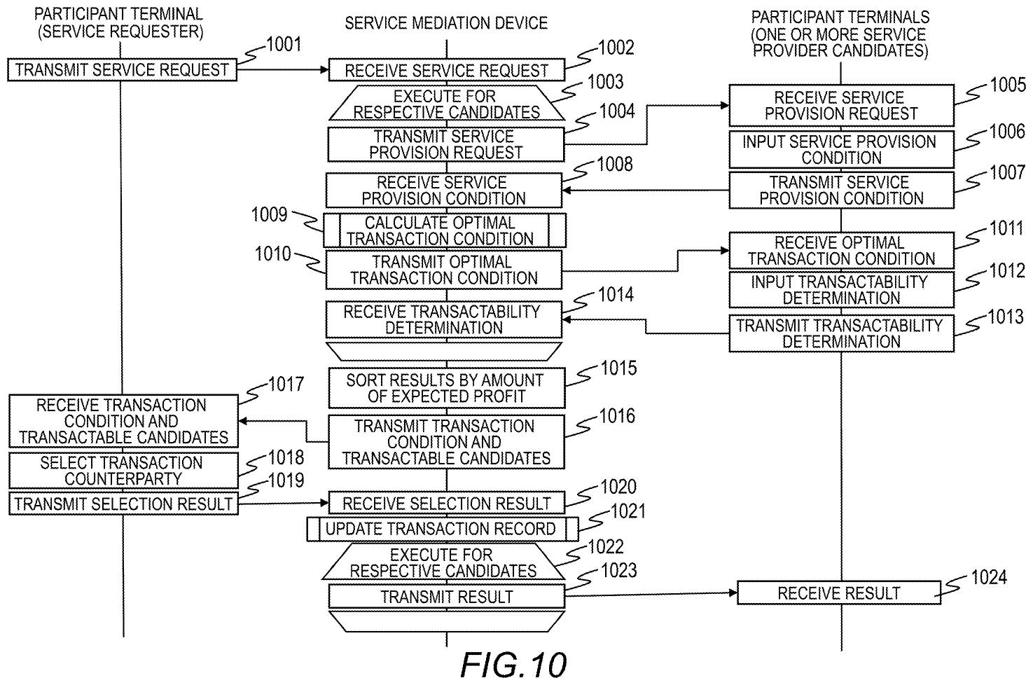

FIG. 10 is a sequence diagram illustrating an example of service mediation processing. Here, the participant terminal 160 of the service requester transmits a service request to the service mediation device 100 (1001). For example, the service ID of the requested service is determined on the basis of the input to the participant terminal 160 of the service requester.

The service requester inputs the estimate (hereinafter, also referred to as Br) of (necessary) profit obtained by the service requester receiving the service (that is, the thing the service requester obtains from the service provider through the transaction (excluding the money delivered at the time of transaction, the same applies hereinafter)) and the estimate (hereinafter, also referred to as Lr) of (acceptable) loss incurred by the service requester receiving the service (that is, the loss incurred due to the thing the service requester obtains from the service provider through the transaction) to the participant terminal 160. The service request includes the service ID, Br, Lr, and the participant ID (service requester ID) of the participant terminal 160. The Br and Lr may not be determined on the basis of the input by the service requester, and may be preset for each service ID in the participant terminal 160, for example.

The optimal transaction condition calculation unit 111 of the service mediation device 100 receives the service request (1002), and executes the processing of steps 1004, 1008, 1009, 1010, and 1014 which is described below with respect to each participant terminal 160 (the participant terminal 160 possessed by each of one or more service provider candidates) (1003).

The service mediation device 100 may hold information indicating the service IDs of the services that can be provided by the participants having the participant terminals 160 (information indicating the correspondence between the service provider ID and the service ID). In this case, the optimal transaction condition calculation unit 111 may execute the processing of step 1004, step 1008, step 1009, step 1010, and step 1014, which are described below, with respect to only each of the participant terminals 160 (the participant terminals 160 possessed by one or more service provider candidates) possessed by the participants who can provide the service of the service ID indicated by the service request.

The optimal transaction condition calculation unit 111 transmits a service provision request to the participant terminal 160 of the service provider candidate (1004). The service provision request includes, for example, a service requester ID included in the service request and a service ID (which may be a corresponding service name) included in the service request.

The participant terminal 160 of the service provider candidate receives the service provision request (1005), displays a screen illustrating the service provision request on the display device connected thereto, receives the input of the service provision condition from the service provider candidate (1006), and transmits the input service provision condition are transmitted to the service mediation device 100 (1007).

The service provision condition includes, for example, a participant ID (service provider ID) of the participant terminal 160, a service ID (which may be a corresponding service name), and a service provider candidate providing the service, the estimate (hereinafter, also referred to as Bp) of (necessary) profit obtained by the service provider candidate providing the service (that is, the profit obtained from the thing the service provider obtains from the service requester through the transaction), and the estimate (hereinafter, also referred to as Lp) of (acceptable) loss incurred by the service provider candidate providing the service (that is, the loss incurred by the thing the service provider obtains from the service requester through the transaction). The Bp and Lp may not be determined on the basis of the input by the service provider candidate, and may be preset for each service ID in the participant terminal 160, for example.

In addition, the participant terminal 160 of the service provider candidate may accept the input of information indicating that the provision of the service is refused instead of the service provision condition in step 1006. In this case, the participant terminal 160 transmits the information to the service mediation device 100 whereby the participant is excluded from the service provider candidate and is excluded from the target of the processing after step 1009 and the subsequent steps.

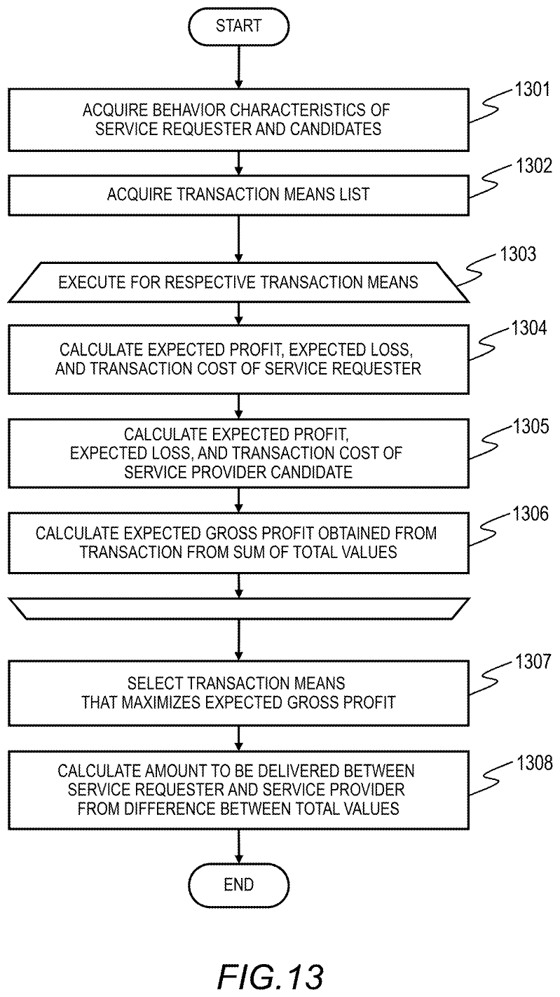

The optimal transaction condition calculation unit 111 receives the service provision condition (1008). The optimal transaction condition calculation unit 111 calculates the optimal transaction condition between the service requester and the service provider candidate on the basis of the service request and the service provision condition (1009). Details of the processing in step 1009 is described below with reference to FIG. 13.

The optimal transaction condition calculation unit 111 transmits the optimal transaction condition calculated in step 1009 to the participant terminal 160 of the service provider candidate (1010). The participant terminal 160 of the service provider candidate receives the optimal transaction condition (1011), displays a screen illustrating the optimal transaction condition on a display device connected thereto, receives the input of whether the service can be provided (transacted) under the optimal transaction condition from the service provider candidate (1012), and transmits the result of the availability to the service mediation device 100 (1013). The optimal transaction condition calculation unit 111 receives the result of the availability (1014). Hereinafter, the service provider candidate who inputs that the service can be provided (transacted) is referred to as a transactable candidate.

The transaction record update unit 112 sorts the optimal transaction conditions between the service requester and each of the transactable candidates in the order of the magnitude of the expected profit (1015), and transmits information indicating the transactable candidate and the sorted optimal transaction conditions to the participant terminal 160 of the service requester (1016). The magnitude of the expected profit in step 1015 may be the magnitude of the expected profit for the service requester, the magnitude of the expected profit for the transactable candidate, or the sum of the expected profit for the transactor and the expected profit for the transactable candidate.

The participant terminal 160 of the service requester receives the information indicating the transactable candidate and the sorted optimal transaction conditions (1017). The participant terminal 160 of the service requester displays a screen illustrating the transactable candidate and the optimal transaction condition on the display device connected to the service requester, selects the transaction counterparty (that is, the transactable candidate from which the service is to be received) (that is, the transactable candidate with which transaction will be done) according to the input from the service requester (1018), and transmits the selection result to the service mediation device 100 (1019).

In step 1018, the participant terminal 160 may select only one transaction counterparty, or may select a plurality of transactions. Further, in step 1018, the participant terminal 160 of the service requester may request the service mediation device 100 to select a transactable candidate so as to raise the expected profit of the service requester. In this way, the service mediation device 100 may be able to interactively change the transaction condition between the service requester and the service provider.

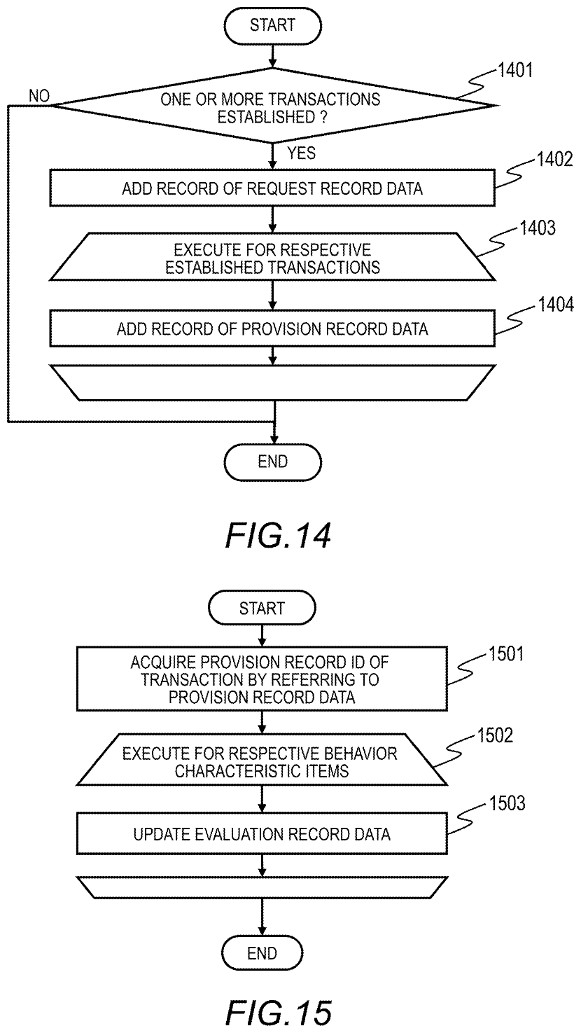

The transaction record update unit 112 receives the selection result (1020). The transaction record update unit 112 updates the transaction record (1021). Details of step 1021 are described below with reference to FIG. 14. The transaction record update unit 112 transmits, for respective transactable candidates (1022), the received selection result (whether the transactable candidate is selected as a transaction counterparty) to the participant terminal 160 of the transactable candidate (1023), and the participant terminal 160 receives the selection result (1024) and ends the service mediation processing.

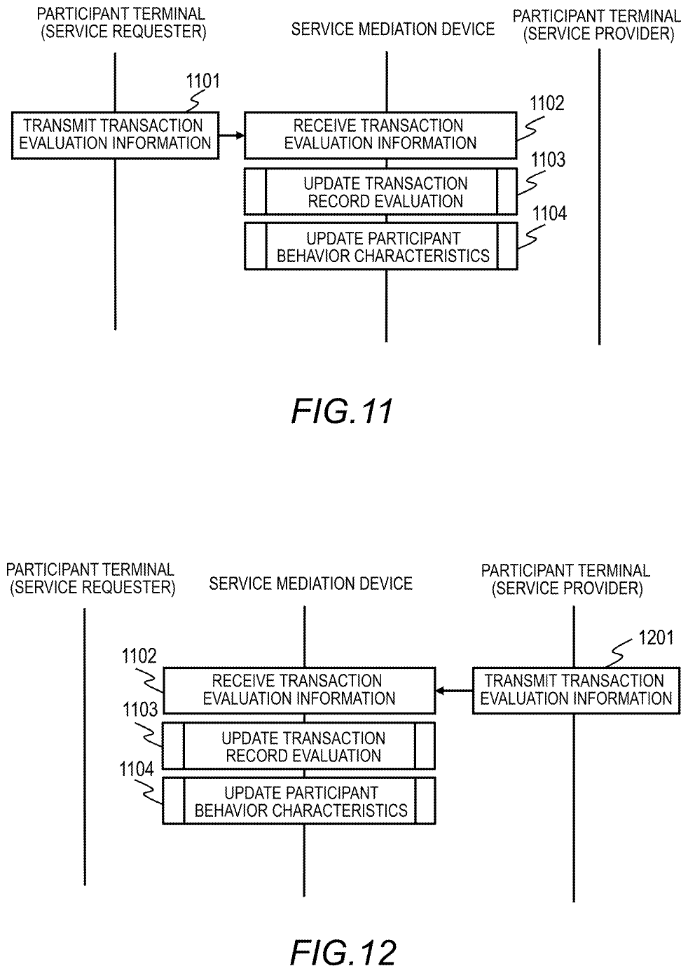

FIG. 11 is a sequence diagram illustrating an example of transaction record evaluation processing from the service requester to the service provider. The transaction record evaluation processing is performed at a predetermined timing, for example, after the transaction between the service requester and the service provider starts (for example, after the transaction is matched or after provision of the service is started) (the same applies to the transaction record evaluation processing of FIG. 12 described later). The participant terminal 160 of the service requester generates transaction evaluation information on the basis of the input from the service requester, and transmits the generated transaction evaluation information to the service mediation device 100 (1101).

The transaction evaluation information includes, for example, an evaluator ID (service requester ID in the example of FIG. 11), a transaction counterparty ID (service provider ID in the example of FIG. 11), a service ID (or service name), and the evaluation value for each behavior characteristic item of the transaction counterparty.

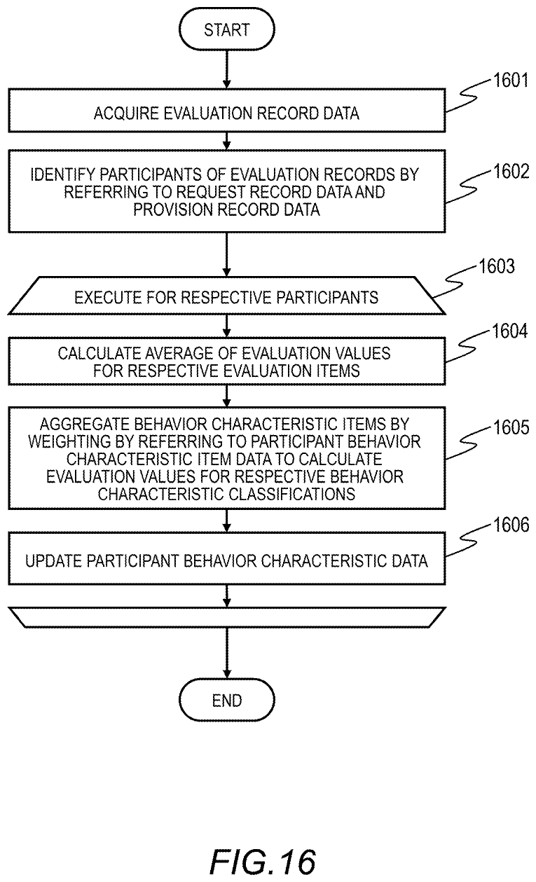

The evaluation record updating unit 113 of the service mediation device 100 receives the transaction evaluation information (1102). The evaluation record update unit 113 executes transaction record evaluation update processing on the basis of the received transaction evaluation information (1103). Details of step 1103 are described below with reference to FIG. 15. The evaluation record update unit 113 executes participant behavior characteristic update processing on the basis of the received transaction evaluation information (1104). Details of step 1104 are described below with reference to FIG. 16.

FIG. 12 is a sequence diagram illustrating an example of the transaction record evaluation processing from the service provider to the service requester. The participant terminal 160 of the service provider generates transaction evaluation information on the basis of the input from the service provider, and transmits the generated transaction evaluation information to the service mediation device 100 (1201).

The transaction evaluation information includes, for example, an evaluator ID (service provider ID in the example of FIG. 12), a transaction counterparty ID (service requester ID in the example of FIG. 12), a service ID (or service name), and the evaluation value of each behavior characteristic item of the transaction counterparty. After the processing of step 1201, the processing of steps 1102 to 1104 similar to that in FIG. 11 are executed.

FIG. 13 is a flowchart illustrating an example of optimal transaction condition calculation processing in step 1009. The optimal transaction condition calculation unit 111 acquires, from the participant behavior characteristic data 125, the behavior characteristic evaluation value of the behavior characteristic classification (profit and loss) corresponding to the participant ID of the service requester and each of the service provider candidates selected in step 1004 (1301).

The behavior characteristic evaluation value corresponding to the information use of the service requester indicates the probability that the service requester properly uses the information provided from the service provider candidate, and is also referred to as Er. The behavior characteristic evaluation value corresponding to the information provision of the service requester indicates the probability that the service requester provides the information expected by the service provider candidate to the service provider candidate, and is also referred to as Ir.

The behavior characteristic evaluation value corresponding to the information provision of the service provider candidate indicates the probability that the service provider candidate properly uses the information provided by the service requester, and is also referred to as Ep. The behavior characteristic evaluation value corresponding to the information use of the service provider candidate indicates the probability that the service provider candidate provides the information expected by the service requester to the service requester, and is also referred to as Ip.

The optimal transaction condition calculation unit 111 loads the service provision method data 123 and acquires a list of service provision methods as a list of transaction means (1302). That is, the optimal transaction condition calculation unit 111 acquires the requester cost, the provider cost, br(i), lr(i), bp(i), and 1p(i) for each transaction means i (each service provision method i).

The optimal transaction condition calculation unit 111 executes the processing of steps 1304 to 1306 described later for each transaction means i (1303). The optimal transaction condition calculation unit 111 calculates Br*br(i)*Ip as the expected profit obtained by the service requester, calculates Lr*lr(i)*(1−Ep) as the expected loss incurred by the service requester, and calculates (acquires) Cr(i) as the transaction cost (1304).

The optimal transaction condition calculation unit 111 calculates Bp*bp(i)*Ir as the expected profit obtained by the service provider candidate, calculates Lp*lp(i)*(1−Er) as the expected loss, and calculates (acquires) Cp(i) as the transaction cost (1305).

The optimal transaction condition calculation unit 111 calculates Gr=Br*br(i)*Ip+Lr*lr(i)*(1−Ep)−Cr(i) as the expected profit that the service requester obtains from the transaction (service), calculates Gp=Bp*bp(i)*Ir−Lp*lp(i)*(1−Er)−Cp(i) as the expected profit that the service provider obtains from the transaction (service), and calculates Gr+Gp as the expected gross profit incurred from the transaction means (service) (1306).

The optimal transaction condition calculation unit 111 selects the transaction means (service) i that maximizes the expected gross profit Gr+Gp generated from the transaction means (service) (1307). The optimal transaction condition calculation unit 111 calculates M satisfying Gr=Br*br(i)*Ip−Lr*lr(i)*(1−Ep)−Cr(i)−M=Bp*bp(i)*Ir−Lp*lp(i)*(1−Er)−Cp(i)+M=Gp (that is, the amount M to be delivered between the service requester and the service provider so that the profit obtained by the service requester is equal to the profit obtained by the service provider candidate) (1308), and ends the optimal transaction condition calculation processing. If M is a negative number, the amount is delivered from the service provider to the service requester.

For example, when a service is provided in which a service requester provides information to a service provider and the service provider delivers money to the service requester, the first item of Gr and the second term of Gp are 0.

Further, for example, when a service is provided in which a service requester delivers money to a service provider and the service provider provides information to the service requester, the second term of Gr and the second term of Gp are 0.

When the optimal transaction condition calculation unit 111 selects the transaction means that maximizes Gr+Gp as described above, the transaction condition by such transaction means that a large profit is obtained for both the service requester and the service provider candidate is calculated. Therefore, the transaction is likely to be established (service mediation is likely to succeed).

Further, when the optimal transaction condition calculation unit 111 determines M as described above, the expected profit obtained by the service requester is equal to the expected profit obtained by the service provider candidate. Therefore, fair transactions can be realized between the service requester and the service provider candidate.

In step 1307, the optimal transaction condition calculation unit 111 may select and output only the transaction means having Gr>0 and Gp>0. As a result, the optimal transaction condition calculation unit 111 can calculate the transaction condition such that the profit amount is positive for both the service requester and the service provider candidate, and the transaction is likely to be established (service mediation is likely to succeed). Further, the optimal transaction condition calculation unit 111 may select and output the transaction means that maximizes Gr+Gp (that is, maximizes the gross profit incurred by the transaction) among the transaction means having Gr>0 and Gp>0.

In addition, the optimal transaction condition calculation unit 111 may calculate a transaction condition that is advantageous to either the service requester or the service provider candidate. Specifically, in step 1307, for example, the optimal transaction condition calculation unit 111 may select such transaction means that maximizes wGr+(1−w)Gp with respect to the weight w(0≤w≤1) determined by the user of the service mediation device 100, for example.

FIG. 14 is a flowchart illustrating an example of transaction record update processing in step 1021. The transaction record update unit 112 determines whether one or more transactions (service mediations) have been established by referring to the selection result received in step 1020 (1401). When it is determined that there is no established transaction (1401: No), the transaction record update unit 112 ends the transaction record update processing.

When it is determined that one or more transactions have been established (1401: Yes), the transaction record update unit 112 adds a record to the request record data 126 (1402). Specifically, the transaction record update unit 112 issues a request record ID for each established transaction (service mediation), and stores a record in which the service requester ID and the service ID corresponding to the transaction are associated with the issued request record ID in the request record data 126.

The transaction record update unit 112 adds the record of the provision record data 127 (1404) to each of the established transactions (service mediations) (1403), and ends the transaction record update processing. In step 1404, specifically, the transaction record update unit 112 issues a provision record ID for each of the established transactions, and adds a record in which the request record ID issued in step 1402 and the service provider ID are associated with the issued provision record ID to the provision record data 127.

FIG. 15 is a flowchart illustrating an example of the transaction record evaluation update processing in step 1103. The evaluation record update unit 113 acquires the provision record ID of the transaction indicated by the transaction evaluation information by referring to the provision record data 127 (1501). The evaluation record update unit 113 updates the evaluation record data 128 (1503) for each behavior characteristic item (1502), and ends the transaction record evaluation update processing.

In step 1503, specifically, the evaluation record update unit 113 issues the evaluation record ID for each combination of the provision record ID, the participant role (whether the evaluation target is the service requester or the service provider), and the participant behavior characteristic item ID, and adds a record in which the evaluation record ID, the provision record ID, the participant role, the participant behavior characteristic item ID, and the transaction evaluation value corresponding to the combination indicated by the transaction evaluation information are associated to the evaluation record data 128.

FIG. 16 is a flowchart illustrating an example of the participant behavior characteristic update processing in step 1104. The participant behavior characteristics update unit 114 acquires the evaluation record data 128 (1601). The participant behavior characteristics update unit 114 associates the provision record ID of the evaluation record data 128 with the provision record ID of the provision record data 127, and associates the request record ID of the provision record data 127 with the request record ID of the request record data 126 to thereby identify the participant of each record of the evaluation record data (the participant indicated by the service requester ID in the request record data 126 when the participant role is the service requester and the participant indicated by the service provider ID in the provision record data 127 when the participant role is the service provider) (1602).

The participant behavior characteristics update unit 114 executes the processing of steps 1604 to 1606 described later for each of the participants identified in step 1602 (1603), and ends the participant behavior characteristic update processing. The participant behavior characteristics update unit 114 calculates the average of the evaluation values for each behavior characteristic classification of the participant (1604).

The participant behavior characteristics update unit 114 identifies the behavior characteristic classification to which each behavior characteristic item ID belongs and the behavior characteristic weight corresponding to each behavior characteristic item ID by referring to the participant behavior characteristic item data 124, and calculates, for each behavior characteristic classification, the sum of the values obtained by multiplying the behavior characteristic weight by each of the averages calculated in step 1604, of the behavior characteristic item ID belonging to the behavior characteristic classification as the behavior characteristic evaluation value of the behavior characteristic classification of the participant (1605). The participant behavior characteristics update unit 114 stores the calculated behavior characteristic evaluation value in the participant behavior characteristic data (1606).

The participant behavior characteristics update unit 114 can determine Ip, Lp, Ir, and Lr on the basis of the evaluation from the other party in the past transaction (received or provided service) by calculating the behavior characteristic evaluation value in each behavior characteristic classification of each participant as described above. In this way, the expected profit and the expected loss used for calculating the optimum transaction conditions can be calculated more accurately.

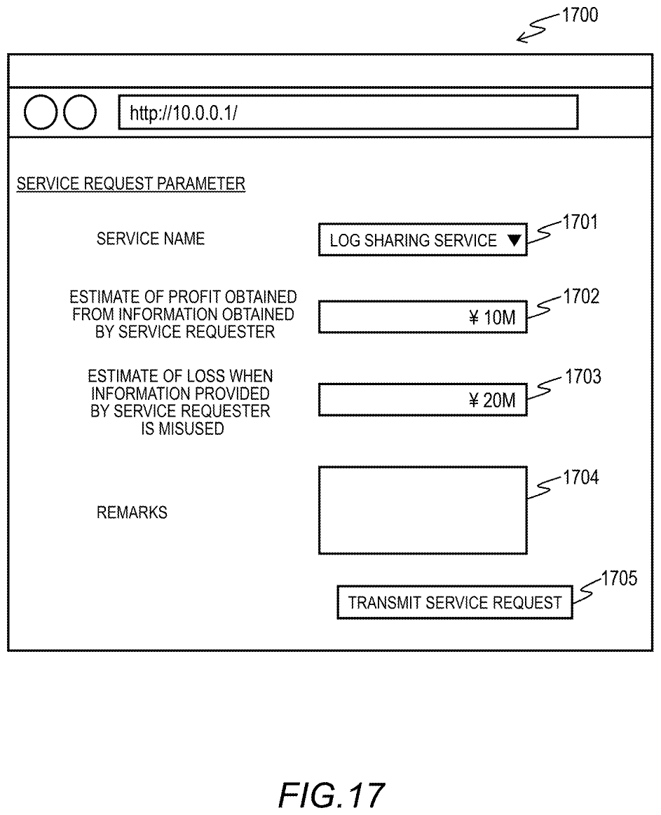

FIG. 17 is an example of the service request input screen displayed on the participant terminal 160 of the service requester in step 1001. A service request input screen 1700 includes, for example, a service name selection area 1701, a service requester profit estimate input area 1702, a service requester loss estimate input area 1703, a remarks input area 1704, and a service request transmit button 1705.

The service name selection area 1701 is an area for displaying and selecting a service name in a dropdown manner. The service requester profit estimate input area 1702 is an area for inputting an estimated profit (Br) obtained from the information acquired by the service requester. The service requester loss estimate input area 1703 is an area for inputting an estimated loss (Lr) when the information provided by the service requester is misused.

The remarks Input area 1704 is an area for inputting remarks. When the service request transmit button 1705 is selected with information input in at least the service name selection area 1701, the service requester profit estimate input area 1702, and the service requester loss estimate input area 1703, the service request is transmitted to the service mediation device 100.

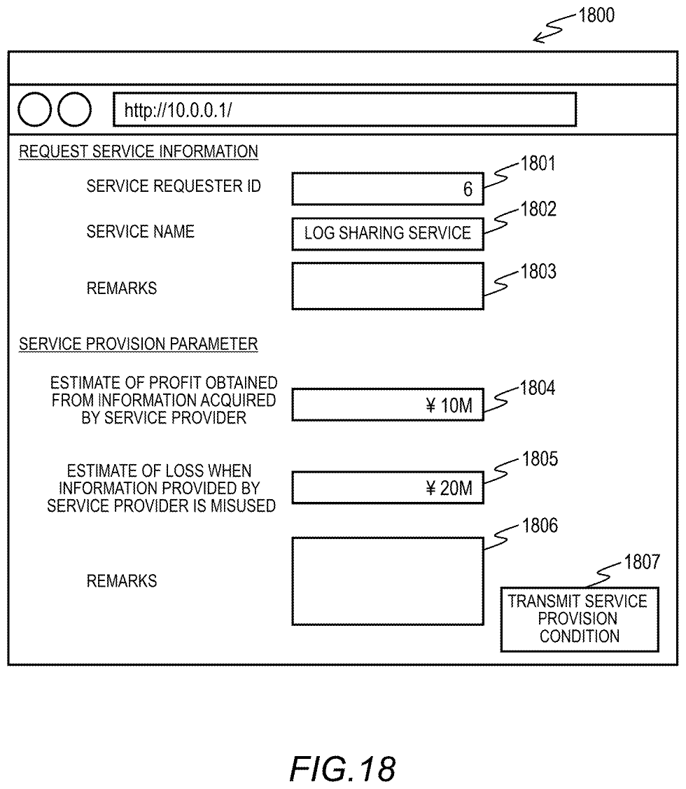

FIG. 18 is an example of a service provision condition input screen displayed on the participant terminal 160 of the service provider candidate in step 1006. The service provision condition input screen 1800 includes, for example, a service requester ID display area 1801, a service name display area 1802, a remarks display area 1803, a service provider profit estimate input area 1804, a service provider loss estimate input area 1805, a remarks input area 1806, and a service provision condition transmit button 1807.

In the service requester ID display area 1801, the participant ID (service requester ID) of the participant who transmitted the service request is displayed. In the service name display area 1802, the service name selected in the service name selection area 1701 is displayed. In the remarks display area 1803, the remarks input in the remarks input area 1704 are displayed.

The service provider profit estimate input area 1804 is an area for inputting the estimated profit (Bp) obtained from the information acquired by the service provider. The service provider loss estimate input area 1805 is an area for inputting the estimated loss (Lp) when the information provided by the service provider is misused. When the service provision condition transmit button 1807 is selected with information input in at least the service provider profit estimate input area 1804 and the service provider loss estimate input area 1805, the service provision condition is transmitted to the service mediation device 100.

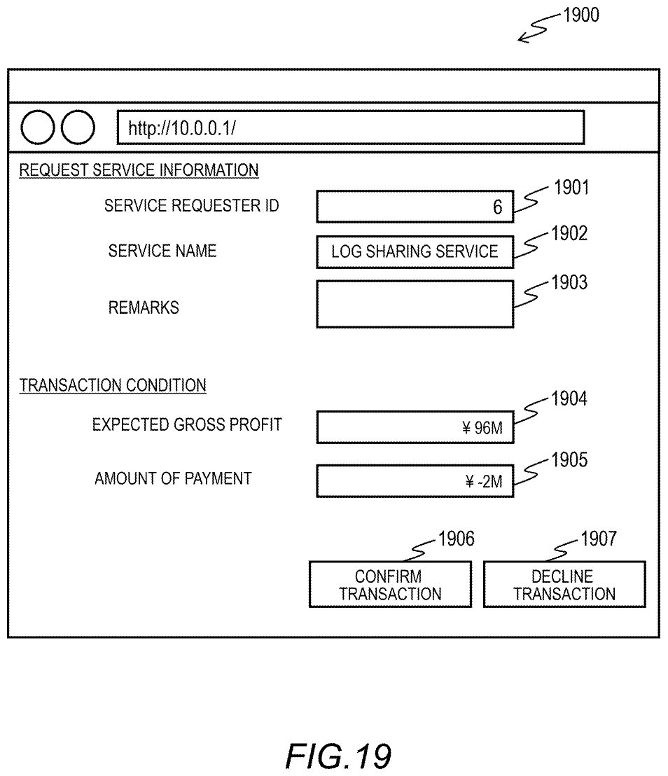

FIG. 19 is an example of a transactability determination input screen displayed on the participant terminal 160 of the service provider candidate in step 1012. The transactability determination input screen 1900 includes, for example, a service requester ID display area 1901, a service name display area 1902, a remarks display area 1903, an expected gross profit display area 1904, a payment amount display area 1905, a transaction confirmation button 1906, and a transaction decline button 1907.

In the service requester ID display area 1901, the participant ID (service requester ID) of the participant who transmitted the service request is displayed. In the service name display area 1902, the service name selected in the service name selection area 1701 is displayed. In the remarks display area 1903, the remarks input in the remarks input area 1704 are displayed.

In the expected gross profit display area 1904, Gr+Gp, which is the sum of the expected gross profits obtained by the service requester and the service provider candidate, calculated in the optimal transaction condition calculation processing of step 1009, is displayed. In addition, in the expected gross profit display area 1904, Gp, which is the expected gross profit obtained by the service provider candidate, may be displayed in place of or in addition to Gr+Gp. In the payment amount display area 1905, the amount of payment that the service provider pays to the service requester when the transaction is established is displayed. In the example of FIG. 19, since a negative value is input in the payment amount display area 1905, money is paid from the service requester to the service provider when the transaction is established.

When the transaction confirmation button 1906 is selected, a transactability determination indicating that the transaction is possible is transmitted to the service mediation device 100, whereas when the transaction decline button 1907 is selected, a transactability determination indicating that the transaction is declined (transaction impossible) is transmitted to the service mediation device 100.

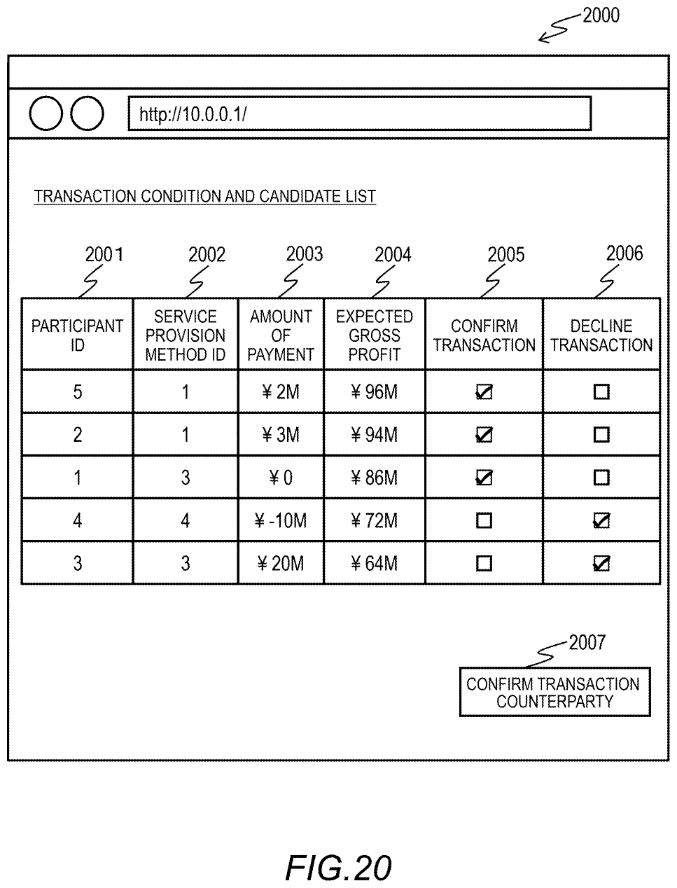

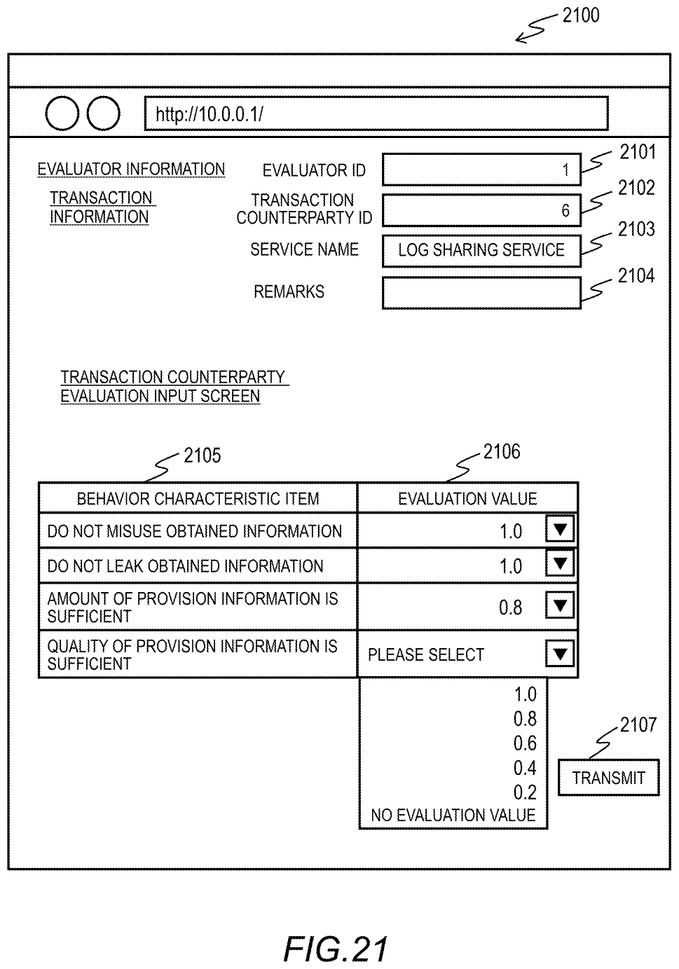

FIG. 20 is an example of a transaction counterparty selection screen displayed on the participant terminal 160 of the service requester in step 1018. On the transaction counterparty selection screen 2000, a list of transactable candidates entered as transactable in the transactability determination and the transaction condition between the service requester and each of the transactable candidates are displayed.

The transaction counterparty selection screen 2000 includes a participant ID display area 2001, a service provision method ID display area 2002, a payment amount display area 2003, an expected gross profit display area 2004, a transaction confirmation checkbox 2005, and a transaction decline checkbox. In the participant ID display area 2001, the participant ID of the transactable candidate is displayed. In addition to or in addition to the participant ID, information acquired from the participant data 121 such as the name (participant name), capital, number of employees, location, and/or last-term profit of the transactable candidate may be displayed.

The service provision method ID is displayed in the service provision method ID display area 2002. In addition to or in addition to the service provision method ID, information acquired from the service data 122 such as the service name, the request data item, and/or the provision data item may be displayed. In the payment amount display area 2003, the amount of payment that the service requester pays to the service provider when the transaction is established is displayed.

In the expected gross profit display area 2004, Gr+Gp, which is the sum of the expected gross profits obtained by the service requester and the service provider candidate, calculated in the optimal transaction condition calculation processing of step 1009, is displayed. In the expected gross profit display area 2004, Gr, which is the expected gross profit obtained by the service requester, may be displayed in place of or in addition to Gr+Gp.

By checking either the transaction confirmation checkbox 2005 or the transaction decline checkbox 2006 of each participant (service provider candidate), it is possible to select whether to confirm or decline the transaction with each participant. If the transaction counterparty confirmation button 2007 is selected with either the transaction confirmation checkbox 2005 or the transaction decline checkbox 2006 of all participants (service provider candidates) checked, the selection result of the transaction counterparty is transmitted to the service mediation device 100.

FIG. 21 is an example of the transaction evaluation information input screen displayed in steps 1101 and 1201. The transaction evaluation information input screen 2100 includes, for example, an evaluator ID display area 2101, a transaction counterparty ID display area, a service name display area 2103, a remarks display area 2104, a behavior characteristic item display area, an evaluation value selection area 2106, and a transmit button 2107.

In the evaluator ID display area 2101, the participant ID of the participant who inputs the transaction evaluation information (the service requester in step 1101 or the service provider in step 1201) is displayed. In the transaction counterparty ID display area 2102, the participant ID of the participant to be evaluated (the service provider in step 1101 or the service requester in step 1201) is displayed. In the service name display area 2103, the service name provided in the transaction is displayed. In the remarks display area 2104, the remarks input in the remarks input area 1704 are displayed.

A list of behavior characteristic items is displayed in the behavior characteristic item display area 2105. The evaluation value selection area 2106 displays evaluation values in a drop-down manner so as to be selected for each behavior characteristic item. The evaluation value may be directly input to the evaluation value selection area 2106, for example, with a numerical value in a predetermined range (for example, 0 or more and 1 or less).

In addition, for example, when a service requester makes a transaction of obtaining information by giving money to a service provider, since the service provider does not obtain information for the behavior characteristic items “do not misuse obtained information” and “do not leak obtained information,” the service requester cannot make evaluation. Therefore, the evaluation value selection area 2106 includes a value of “no evaluation value”, and in such a case, “no evaluation value” is selected. When “no evaluation value” is selected, the value of “no evaluation value” may not be considered in the calculation of the behavior characteristic evaluation value (that is, the record of “no evaluation value” in the evaluation record data 128 is treated as being not present), and may be treated as a predetermined value.

When the transmit button 2107 is selected after the evaluation values of all the behavior characteristic items are selected in the evaluation value selection area 2106, the transaction evaluation information is transmitted to the service mediation device 100.

Although the present disclosure has been described with reference to example embodiments, those skilled in the art will recognize that various changes and modifications may be made in form and detail without departing from the spirit and scope of the claimed subject matter.

For example, the above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration. The above-described configurations, functions, and processors, for all or a part of them, may be implemented by hardware: for example, by designing an integrated circuit.

The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings show control lines and information lines as considered necessary for explanations but do not show all control lines or information lines in the products. It can be considered that almost of all components are actually interconnected.

What is claimed is:

1. A transaction mediation device that mediates between a first participant requesting a transaction and one or more second participants capable of responding to the request of the transaction, comprising:
a processor; and
a memory, wherein
the memory is configured to store:
transaction request information indicating estimates of profit and loss incurred on the basis of a thing that the first participant obtains through the transaction;
for each of the one or more second participants, transaction provision information indicating estimates of profit and loss incurred on the basis of a thing that the second participant obtains through the transaction; and
for each of the first participant and the one or more second participants, behavior characteristic information indicating evaluation of behavior characteristics that affect the profit and loss of a transaction counterparty, and
the processor is configured to:
for each of the one or more second participants,
calculate a first expected profit that the first participant obtains through the transaction with the second participant on the basis of the transaction request information and the behavior characteristic information;
calculate a second expected profit that the second participant obtains through the transaction with the first participant on the basis of the transaction provision information and the behavior characteristic information; and
calculate and output a gross profit incurred from the transaction on the basis of the first expected profit and the second expected profit.

2. The transaction mediation device according to claim 1, wherein
the transaction request information indicates a first estimate of profit incurred on the basis of a thing that the first participant obtains through the transaction and a second estimate of loss incurred on the basis of the thing,
the transaction provision information indicates a third estimate of profit incurred on the basis of a thing that each of the one or more second participants obtains through the transaction and a fourth estimate of loss incurred on the basis of the thing,
the behavior characteristic information indicates evaluations of a first behavior characteristic that affects the profit of the transaction counterparty and a second behavior characteristic that affects the loss of the transaction counterparty for each of the first participant and the one or more second participants, and
the processor is configured to:
for each of the one or more second participants,
calculate a first expected value of the profit that the first participant obtained through the transaction with the second participant on the basis of the first estimate, the second estimate, and the evaluations of the first behavior characteristic and the second behavior characteristic of the second participant indicated by the behavior characteristic information; and
calculate a second expected value of the profit that the second participant obtains through the transaction with the first participant on the basis of the third estimate, the fourth estimate, and the evaluations of the first behavior characteristic and the second behavior characteristic of the first participant indicated by the behavior characteristic information.

3. The transaction mediation device according to claim 1, wherein
the processor is configured to:
for each of the one or more second participants,
determine an amount of money delivered from the first participant to the second participant or from the second participant to the first participant so that the first expected value and the second expected value are equal to each other;
calculate and output the gross profit on the basis of the first expected value and the second expected value to or from which the determined amount of money is added or subtracted; and
output the determined amount of money.

4. The transaction mediation device according to claim 1, wherein
the processor calculates and outputs the gross profit on the basis of the first expected value and the second expected value corresponding to the second participant in which the first expected value and the second expected value are both greater than 0.

5. The transaction mediation device according to claim 4, wherein
The processor calculates and outputs the gross profit on the basis of the first expected value and the second expected value corresponding to the second participant in which a sum of the first expected value and the second expected value is maximized among combinations of second participants in which the first expected value and the second expected value are both greater than 0.

6. The transaction mediation device according to claim 1, wherein
the memory stores transaction means information indicating a first correction coefficient for correcting the profit of the first participant, a second correction coefficient for correcting the loss of the first participant, and a third correction coefficient for correcting the profit of the one or more second participants, and a fourth correction coefficient for correcting the loss of the one or more second participants, the transaction means information being defined for each transaction means, and
the processor is configured to:
for each of the one or more second participants,
calculate the first expected value on the basis of the transaction request information, the behavior characteristic information, the first correction coefficient, and the second correction coefficient; and
calculate the second expected value on the basis of the transaction request information, the behavior characteristic information, the third correction coefficient, and the fourth correction coefficient.

7. The transaction mediation device according to claim 1, wherein
the memory stores evaluation information indicating an evaluation value by one participant, of behavior characteristics of the other participant in the transaction and an evaluation value by the other participant, of behavior characteristics of the one participant for each combination of participants who have a record of established transactions, and
the processor is configured to:
acquire the evaluation value by the first participant, of the behavior characteristics in transaction of the second participant who has established the transaction with the first participant and the evaluation value by the second participant, of the behavior characteristics in the transaction of the first participant;
for each of the behavior characteristics,
calculate evaluation of the behavior characteristic of the first participant to be stored in the behavior characteristic on the basis of an average of the evaluation value included in the evaluation information of the first participant and the acquired evaluation value of the first participant;
calculate evaluation of the behavior characteristic of the second participant to be stored in the behavior characteristic information on the basis of an average of the evaluation value included in the evaluation information of the second participant and the acquired evaluation value of the second participant; and
update the behavior characteristic information using the calculated evaluation of the behavior characteristic of the first participant and the calculated evaluation of the behavior characteristic of the second participant.

8. The transaction mediation device according to claim 7, wherein
the transaction mediation device is connected to a first device and a second device, and
the processor is configured to:
display, on the first device, a screen for inputting the evaluation value by the first participant, of each behavior characteristic in the transaction of the second participant who has established the transaction with the first participant; and
display, on the second device, a screen for inputting the evaluation value by the second participant, of each behavior characteristic in the transaction of the first participant.

9. The transaction mediation device according to claim 1, wherein
the transaction mediation device is connected to a first device and a second device, and
the processor is configured to:
display, on the first device, a screen for inputting estimates of profit and loss incurred on the basis of the thing that the first participant obtains through the transaction;
display, on the second device, a screen for inputting estimates of profit and loss incurred on the basis of the thing that the second participant obtains through the transaction;
upon receiving the estimates of the profit and loss incurred on the basis of the thing that the first participant obtains through the transaction from the first participant, generate the transaction request information on the basis of the received estimates; and
upon receiving the estimates of the profit and loss incurred on the basis of the thing that the second participant obtains through the transaction from the second device, generate the transaction provision information on the basis of the received estimates.

10. A transaction mediation method, by a transaction mediation device, that mediates between a first participant requesting a transaction and one or more second participants capable of responding to the request of the transaction,
the transaction device comprising:
a processor; and
a memory, wherein
the memory is configured to store:
transaction request information indicating estimates of profit and loss incurred on the basis of a thing that the first participant obtains through the transaction;
for each of the one or more second participants, transaction provision information indicating estimates of profit and loss incurred on the basis of a thing that the second participant obtains through the transaction; and
for each of the first participant and the one or more second participants, behavior characteristic information indicating evaluation of behavior characteristics that affect the profit and loss of a transaction counterparty, and
the transaction mediation method comprising:
for each of the one or more second participants,
calculating, by the processor, a first expected profit that the first participant obtains through the transaction with the second participant on the basis of the transaction request information and the behavior characteristic information;
calculating, by the processor, a second expected profit that the second participant obtains through the transaction with the first participant on the basis of the transaction provision information and the behavior characteristic information; and
calculating and outputting, by the processor, a gross profit incurred from the transaction on the basis of the first expected profit and the second expected profit.
